(19) United States
(12) Patent Application Publication
(10) Pub. No.: US 2026/0111874 A1
(43) Pub. Date: Apr. 23, 2026

(54) SYSTEM AND METHOD OF CHIPPLYA ELECTRONIC WALLET

(71) Applicant: Preska Thomas, Port St. Lucie, FL (US)

(72) Inventor: Preska Thomas, Port St. Lucie, FL (US)

(21) Appl. No.: 18/919,814

(22) Filed: Oct. 18, 2024

(51) Int. Cl. G06Q 20/36; G06Q 20/38; G06Q 30/0273

(52) U.S. Cl. CPC G06Q 20/363; G06Q 20/3829; G06Q 30/0274

(57) ABSTRACT

A system for managing digital assets held by digital wallets is provided. The system comprises an electronic device and an electronic wallet application stored at least in the device that when executed enables minting of at least one customer logo or facial recognition Non-fungible Token (NFT) as directed by user entries. The system lists the NFT on a DebitMyData platform, receives a message that the NFT has been sold in a transaction, and validates and logs the transaction on a blockchain. The platform integrates facial recognition technology with a blockchain-based NFT advertising model to allow users to place logos on NFTs and videos for sharing on social media and mobile devices. The platform pays users a percentage of advertising dollars spent by corporate sponsors and advertisers who use logos placed on NFTs by the users. The application tokenizes personal data into NFTs which are manageable and tradeable on the blockchain.

### CROSS REFERENCE TO RELATED APPLICATIONS

None

### FIELD OF THE DISCLOSURE

The present disclosure is in the field of electronic commerce. More particularly, the present disclosure provides systems and methods of an electronic wallet supporting management of multiple types of digital assets and that works closely with a logo and facial recognition website that creates and sells digital assets, sells advertising in which such assets are embedded, and shares advertising revenue with creators of such assets with transactions documented in a blockchain.

### BACKGROUND

The rapid growth of digital assets and non-fungible tokens (NFTs) has transformed the way value, ownership, and digital content are perceived. NFTs have unlocked opportunities for artists, collectors, and businesses, enabling the unique representation and transfer of digital assets on blockchain platforms. However, the current NFT ecosystem is facing challenges related to energy consumption, storage, advertising, user data monetization, and cybersecurity, each of which hinders the widespread adoption and long-term sustainability of digital assets and NFTs

The advent of blockchain technology has paved the way for new opportunities in various industries, particularly the world of digital assets and NFTs. These unique tokens have emerged as powerful tools for artists, collectors, and businesses to represent and transfer digital assets securely and transparently. As the NFT market continues to grow, several challenges have emerged that limit its potential and hinder widespread adoption.

### BRIEF DESCRIPTION OF THE DRAWING

FIG. 1 is an image of a mobile device hosting the electronic wallet and a display of services provided by the wallet and associated websites.

### DETAILED DESCRIPTION

Systems and methods described herein provide a digital wallet solution positioned as a credit card, debit card, and gift card choice for banking institutions, credit unions and financial service companies. The wallet integrates technologies including blockchain, artificial intelligence (AI) driven analytics, biometric security, and quantum-resistant encryption.

The system, which may be referred to commercially as the ChipplyA Wallet interacts with various components, including smartphones, a DebitMyData Custom Logo and Facial Recognition website, blockchain, Internet-Of-Things (IoT), Ad server, banking networks, cryptocurrency, mobile carriers, telecommunications, quantum, voice recognition and satellites. Each connection is directed to supporting secure data flow and integration.

The digital wallet works directly with the DebitMyData Custom Logo and Facial Recognition platform or website. The platform integrates facial recognition technology with a blockchain-based NFT advertising model to allow users to place logos on NFTs and videos for sharing on social media and mobile devices. The platform pays users a percentage of advertising funds spent by corporate sponsors and others who advertise on the site and who use logos placed on NFTs by the users of the site. DebitMyData is described at length in U.S. Non-Provisional patent application Ser. No. 18/129,785 filed on Mar. 31, 2023, also submitted by the inventor named in the present disclosure.

The electronic wallet application uses blockchain as its foundational ledger system. This ledger records most or all transactions such as NFT sales, purchases, transfers, and ad space sales in a tamper-proof, transparent, and decentralized manner.

The wallet is connected to a distributed blockchain ledger, such that transactions are validated by a network of nodes. This may support decentralization and data integrity. Actions executed within the wallet application such as creation of NFTs, selling of advertising space, and financial transactions are securely logged on the blockchain. Such secure logging supports immutability of data and resistance to fraud.

Personal data may be tokenized into NFTs, which can be managed and traded on the blockchain. Tokenization may give users greater control over how their data is monetized.

Blockchain may support high security for user data and transactions. For decentralized identity (DID), the electronic wallet can employ decentralized identity solutions where users control their data on the blockchain. Facial recognition may be linked to blockchain-based decentralized identities to secure user interactions.

For private key management, users have private keys to their wallets, promoting that only they can authorize transactions. Blockchain's security protocol promotes that no one can access funds or NFTs without the user's consent.

The system also supports quantum-resistant encryption. For added protection against future threats, for example with quantum computing, the electronic wallet provided herein may integrate blockchain protocols with quantum-resistant encryption algorithms.

Smart contracts have an important function in automating and executing predefined conditions, particularly in NFT and advertising transactions. for advertising space sales, when an advertiser buys ad space on an NFT through the wallet, a smart contract will automate the transaction. The wallet application oversees the secure transfer of payments to NFT owners and distributes a portion, for example 5%, of the ad buy to the account of the NFT creator. The wallet embeds the advertiser's logo or other media on the NFT.

For NFT transfers and monetization, smart contracts can manage the transfer of ownership of NFTs and enable payments when NFTs are sold or rented. For revenue sharing, smart contracts enable payouts to end users when their data or NFTs are used for advertising. This may support transparency and remove a need for intermediaries.

The wallet application is built with a modular architecture which may ease integration of new features and updates without disrupting existing functionalities. The electronic wallet includes application programming interfaces (API) and software development kits (SDK) that enables developers to create custom applications and integrate the electronic wallet with external systems and platforms, particularly those used by banks and financial institutions.

The wallet is compatible with a range of devices including smartphones, tablets, laptops, and dedicated hardware wallets. For further security, the wallet may integrate with hardware security modules (HSM), providing a secure environment for generating, storing, and managing cryptographic keys.

The wallet is built for high-speed transactions. The wallet leverages off-chain scaling solutions, for example state channels and Layer 2 protocols to ensure rapid transaction processing with minimal latency.

For scalability, the electronic wallet is designed to handle a large number of users and transactions simultaneously. The wallet scales vertically and horizontally in an event user demand grows.

Regarding regulatory compliance, the electronic wallet complies with relevant financial regulations, including Anti-Money Laundering (AML) and Know Your Customer (KYC) requirements. The wallet adheres to industry standards for blockchain and digital asset management, including those set by the International Organization for Standardization (ISO) and the Payment Card Industry Data Security Standard (PCI DSS).

The wallet application supports various blockchain-based cryptocurrencies for seamless and secure payments. Users can store, send, receive, and convert multiple cryptocurrencies within the wallet. For multi-currency support, users may perform transactions in popular cryptocurrencies such as Bitcoin or Ethereum or use native tokens developed for DebitMyData. The electronic wallet may use blockchain mechanisms such as Proof of Stake to validate transactions or to incentivize users to hold certain tokens.

The electronic wallet enables minting and trading of NFTs. It allows users to mint custom logo and facial recognition NFTs and list them on the DebitMyData marketplace for sale or use them in other blockchain-integrated applications. Users may create and customize NFTs directly within the wallet, using facial recognition or logos. NFTs can be securely listed for sale on the DebitMyData platform, with transactions validated and logged on the blockchain. The electronic wallet supports token standards such as ERC-721 for NFTs and ERC-20 for fungible tokens. This may promote compatibility with the broader ecosystem of decentralized apps, commonly referred to as dApps.

The Proof of Future concept can be integrated into the wallet's blockchain framework to calculate the value of user-generated data and automatically convert that value into cryptocurrency. The Proof of Future Algorithm is proprietary and calculates the future value of user-generated data based on such things as engagement and relevance. This calculation is sent to miners, who validate the data using blockchain's Proof of Stake (PoS) or Proof of Work (PoW) models.

For automated monetization, the blockchain ensures the process is transparent, with smart contracts automating payments based on data usage. This may promote the creation of reliable ways for users to earn from their data.

The wallet integrates with the Adtech Blockchain Fault-Tolerant (BFT) advertising engine. This feature supports security in advertising transactions. The blockchain nearly guarantees that the ad space sales on NFTs are secure and free of fraud.

Transparency for advertisers is supported as advertisers can verify where their ads are being displayed. This is based in part on blockchain's transparent and trackable nature.

Summarizing, the electronic wallet leverages blockchain for:
Security: Blockchain ensures the security of user data, NFTs, and transactions.
Smart Contracts: Automated and transparent execution of financial transactions and NFT sales.
NFT Integration: Enables NFT minting, trading, and ad space sales.
Monetization: Users earn cryptocurrency through Proof of Future and other monetization mechanisms.

Controls and features provided herein may promote users to have greater control over their digital assets and personal data, provided within a secure and decentralized ecosystem.

The DebitMyData Proof of Future (PoF) is a proprietary model designed to monetize user data and digital interactions in a manner that compensates individuals for their contributions in the digital economy. Unlike traditional models wherein corporations collect and sell user data without compensating the users, DebitMyData's PoF model creates a system where users may directly benefit from the value their data generates over time.

Proof of Future is predicated on an approach that a user's data has inherent and future potential value. The model calculates the future value of user data, particularly focusing on data interactions such as browsing habits, personal preferences, and engagement with digital content. By leveraging blockchain and AI technology, the Proof of Future system quantifies this data and converts it into a financial asset that can be monetized over time.

The Proof of Future model is based on the data users generate while interacting with the internet, apps, and digital platforms. This may include browsing habits and preferences and interactions with advertisements. It may also include content consumption and creation and engagement with NFTs and other digital assets. This data is collected in a privacy-conscious manner and stored securely on the blockchain.

DebitMyData employs a proprietary algorithm to calculate the future value of the data generated by users. Key factors that the algorithm may consider are as follows:
Relevance: How valuable the data is to advertisers, businesses, or platforms.
Engagement: The level of interaction a user has with different types of content, for example viewing ads, liking posts, purchasing items.
Timing: The time frame during which the data was gathered, as data can have fluctuating value depending at least on trends and market demands.
Predictive Analytics: AI-powered predictive analytics to estimate future trends based on past interactions and preferences.

This algorithm creates a score, which is used to determine how much a user's data is worth, both in real time and at points in the future. Once the data is assigned a value using the Proof of Future algorithm, that value is converted into cryptocurrency. This process involves:
Blockchain Validation: The user's data value is validated by a decentralized network of miners or validators using Proof of Stake (PoS) or Proof of Work (PoW) models. This ensures that the valuation is secure, transparent, and immutable.
Smart Contracts: Smart contracts then automatically convert this data value into a cryptocurrency token. The token may be either native to DebitMyData or a compatible crypto such as Ethereum.

The tokens are deposited into the user's wallet account. This allows users to earn cryptocurrency over time as their data continues to be used, generating ongoing financial benefit.

Regarding monetization of advertising space, one of the key applications of the Proof of Future model is through the sale of advertising space on NFTs. The process works as follows:
User Interaction with NFTs: Users can create or upload NFTs with custom logos or facial recognition features through the DebitMyData platform.
Advertisers Buy Ad Space: Advertisers purchase advertising space on these NFTs, which can include embedding their logos or media onto the NFTs.
Monetization through Engagement: As users engage with these NFTs, either by displaying them, selling them, or allowing them to be distributed across networks, for example on social media or IoT devices, the Proof of Future algorithm assesses the value of the particular engagement.
Earnings for Users: Users earn a percentage, for example 5%, of the advertising revenue, which is calculated and distributed in real-time via smart contracts and deposited into their wallet account.

With Proof of Future, data is no longer a static asset. Data may instead grow in value as time passes and as the user continues to engage with the platform and advertisers. It is noteworthy that user data is:
Continuously Evaluated: Data is not just valuable at the moment it is collected but is continuously evaluated for its potential.
Earns Over Time: Just as an investment grows over time, so does the value of the data. Users may check their wallet accounts to see how much their data has earned for them, providing a long-term incentive to remain engaged with the platform.

Proof of Future vs. Proof of Work and Proof of Stake: While traditional blockchain models rely on Proof of Work (PoW) or Proof of Stake (PoS) to validate transactions and maintain the blockchain, Proof of Future introduces a new layer of complexity by quantifying and monetizing future data value. A comparison is as follows:
Proof of Work (PoW): Directed to mining and validating transactions through computational effort.
Proof of Stake (PoS): Directed to validating transactions based on the amount of cryptocurrency a user holds.
Proof of Future (PoF): Directed to validating the future value of user data, essentially allowing users to stake their personal data as a valuable asset, which can then generate revenue as it continues to grow in relevance and engagement.

The electronic wallet provided herein allows users to:
Manage and View Data Earnings: Users can view how much their data is worth at any given time.
Receive Payments: As their data continues to earn through advertisements, engagement, and predictive future value, users receive cryptocurrency payments into their wallet.
Spend or Trade: The cryptocurrency earned from the Proof of Future model can be spent, traded, or reinvested through the DebitMyData marketplace or external crypto exchanges.

Applications of Proof of Future in other industries. Beyond advertising, Proof of Future has the potential to revolutionize other industries where data and user interaction have intrinsic value, such as:
Healthcare: Patient data can be monetized ethically through the Proof of Future model, compensating individuals for their contributions to medical research.
Education: Students' learning behaviors and progress could be turned into data assets that grow in value over time as they engage with educational platforms.
Entertainment: Artists and content creators can monetize their audiences' engagement over time, turning views, likes, and shares into valuable digital assets.

Long-Term Vision of Proof of Future. A principal objective of Proof of Future is to democratize data ownership by empowering individuals to control, manage, and monetize their data on their own terms. By turning data into a long-term financial asset, DebitMyData ensures that users benefit financially from the digital economy, rather than being passive participants whose data is sold without their consent.

DebitMyData's Proof of Future is an innovative model that not only calculates the present value of data but also projects its future value. Through blockchain, smart contracts, and AI-powered algorithms, users can monetize their data over time, creating a new way for individuals to benefit from their digital footprint. The Proof of Future model turns personal data into a tradable, revenue-generating asset, which users can leverage for long-term financial gain.

The electronic wallet and the DebitMyData AI. The DebitMyData AI interact with NFTs (Non-Fungible Tokens) in a variety of ways. This interaction has the potential to enhance the utility, value, and experience of NFTs. Artificial intelligence can be integrated with NFTs as follows:

1. AI-Generated NFTs. The DebitMyData AI creates unique digital content, such as artwork, music, or even entire virtual worlds, which can be minted as NFTs. For example:
Generative Art: AI algorithms like GANs (Generative Adversarial Networks) can generate original artwork based on certain parameters or datasets. These digital art pieces can then be minted and sold as NFTs
AI Music Creation: AI can compose unique pieces of music that can be tokenized as NFTs, offering a new form of digital collectibles.

On the DebitMyData platform, users may use AI to create custom logos, avatars, or other types of digital assets that incorporate facial recognition features, which can then be minted as NFTs.

2. AI-Driven NFT Personalization. The DebitMyData AI enhances NFTs by allowing them to adapt or evolve over time based on user interaction or external data. For example:
Personalized Experiences: NFTs can change their appearance, behavior, or attributes based on user input or real-world data. For instance, an AI-driven NFT could evolve as its owner interacts with it, making it more unique over time.
Dynamic NFTs: AI can enable dynamic NFTs that change based on external factors, such as market trends, user behavior, or environmental data, for example a piece of digital art that changes based on weather data or the time of day.

The DebitMyData AI drives how NFTs evolve based on user interaction, such as how often users engage with an NFT advertisement or how material associated with the NFT and the advertisement is shared across platforms. AI could also update ad performance, target audiences, and engagement metrics, reflected in the NFT's data.

3. AI-Enhanced NFT Marketplaces. The DebitMyData AI can be used in NFT marketplaces to improve the user experience, such as:
AI-Based Recommendations: AI algorithms can recommend NFTs to users based on their browsing history, preferences, or social interactions. This works similarly to how AI is used in ecommerce platforms to suggest products to customers.
AI for Pricing Prediction: The DebitMyData AI analyzes historical transaction data, market trends, and user behaviors to predict the future value of an NFT or help determine a fair market price.

On DebitMyData's NFT marketplace, the DebitMyData AI suggests relevant custom logo or facial recognition NFTs for advertisers based on their target audience and marketing goals. The DebitMyData AI could also predict the potential earnings for users based on their NFT's engagement.

4. The DebitMyData AI and NFT-Based Identity Verification. The DebitMyData AI is effective for identity verification, which is especially important when NFTs represent personal data, digital identities, or other sensitive assets.
Facial Recognition: AI-driven facial recognition is embedded in NFTs for authentication purposes. For example, DebitMyData uses facial recognition to ensure that only the NFT owner can use or monetize a specific digital asset.
Anti-Fraud Systems: AI can be used to detect deepfakes or other forms of identity fraud. In NFT transactions, this capability is important to ensure authenticity and trust in digital assets. The electronic wallet provided herein integrates the DebitMyData AI for secure identity verification, allowing users to easily access their NFTs or manage transactions without risking their data.

5. AI for NFT-Based Advertising. In the context of DebitMyData's advertising model, AI interacts with NFTs to optimize advertisement targeting and performance.
AI-Driven Ad Placement: The DebitMyData AI analyzes user data, engagement metrics, and browsing behavior to identify the most relevant NFTs where advertisers can place their ads. This may result in better targeting, higher engagement rates, and increased revenue for both advertisers and NFT owners.
Real-Time Data Analysis: The DebitMyData AI analyzes real-time data to dynamically adjust placement of advertising content, optimizing for performance and engagement. Advertisers place ads on NFTs that are currently trending or have high engagement rates based on AI analysis.

The DebitMyData AI plays a crucial role in optimizing ad space sales within DebitMyData's custom logo and facial recognition NFTs, promoting advertisers to receive a good return on investment (ROI) and helping users maximize their earnings.

6. AI in NFT-Based Gaming and the Metaverse. AI can interact with NFTs in gaming environments and virtual worlds (metaverse).
Game Character NFTs: The DebitMyData AI enables NFTs to represent in-game characters or assets that evolve and learn based on the player's behavior. These characters could have AI-driven personalities and skills that adapt over time.

Metaverse Interaction: The DebitMyData AI enhances NFTs in the metaverse by allowing avatars, agents, digital assets, or environments to respond intelligently to user input or environmental changes. AI could also help manage economic systems, such as a decentralized marketplace, where NFTs are bought and sold.

DebitMyData's Game of Life Metaverse and Proof of Future is enhanced by AI in several ways, such as creating intelligent avatar and agents that interact with users in a personalized way or predicting the future value of in-game assets based on player activity.

7. AI for Proof of Future and Predictive Value. The DebitMyData AI is integrated into Proof of Future to assess and predict the future value of user data stored in NFTs. By combining AI with Proof of Future, DebitMyData ensures that users benefit financially from their data and interactions with the platform over the long term.
Predictive Analytics: AI can forecast how much a user's data or NFT will be worth based on historical data and market trends. For instance, an NFT representing a user's data could grow in value if AI predicts higher demand for that data in the future.
Continuous Data Analysis: AI can continuously analyze engagement metrics, ensuring that users are compensated fairly based on the evolving value of their data over time.

The DebitMyData AI enhances NFTs in multiple ways, such as personalization, market optimization, identity verification, gaming, and advertising. With DebitMyData, AI has an integral role in driving the value of custom logo and facial recognition NFTs, optimizing the platform's ad server, and ensuring users are fairly compensated through the Proof of Future model. By leveraging AI, DebitMyData creates a more dynamic, secure, and profitable environment for NFT owners, advertisers, and users.

Artificial intelligence can interact directly with blockchain technology. DebitMyData AI interacts directly with blockchain technology in several ways. These interactions create synergies that can enhance security, transparency, and efficiency in various industries. AI interacts with blockchain as follows:

1. Smart Contract Automation and Execution. Blockchain can host smart contracts, which are self-executing contracts with the terms of the agreement directly written into code. AI can be used to:
Trigger Smart Contracts: the DebitMyData AI systems process large amounts of data and automatically trigger smart contracts based on predefined conditions. For example, in supply chain management, AI can track real-time data (such as shipment locations), and once the conditions for delivery are met, it invokes release of payments via a smart contract.
Optimize Smart Contracts: The DebitMyData AI analyzes performance of smart contracts and suggests optimizations, such as adjusting gas fees (transaction fees) based on network traffic or identifying bugs or inefficiencies in contract code.

2. AI-Driven Decision Making. The DebitMyData AI can analyze and interpret large datasets and provide insights. Blockchain can make these AI-driven decisions tamper-proof:
Data-Driven Decisions: AI algorithms can process off-chain and on-chain data, such as financial transactions, user activity, or market trends, to make decisions. These decisions can then be recorded on the blockchain, ensuring a permanent, auditable trail. Decentralized Autonomous Organizations (DAOs): In DAOs, AI can be used to automate decision-making processes, such as voting systems, investment decisions, or resource allocations. The decisions made by AI can be validated and secured through blockchain.

3. Data Integrity and Verification. One issue with AI models is data quality, as AI systems require large datasets for training and validation. Blockchain can address this issue in several ways:
Verification of Data Authenticity: Blockchain can store the provenance of data, ensuring that the datasets used for AI training and decision-making are authentic, unaltered, and verified by multiple nodes in the network. This is particularly important for AI models in industries such as healthcare, finance, and legal, where data integrity is critical.
Prevention of Data Manipulation: Once data is recorded on the blockchain, it becomes immutable. This immutability ensures that the data used by AI systems for analysis or model training cannot be tampered with, enhancing trust and reliability in AI outputs.

4. Data Sharing and Monetization. AI analyzes and monetizes data stored on the blockchain:
Decentralized Data Marketplaces: Blockchain can host decentralized marketplaces where users can sell or share their data. AI can play a role by analyzing the data, identifying valuable insights, or predicting market trends. This is a key feature of DebitMyData, where users can monetize their data, and AI can optimize the pricing or usage of that data.
Secure Data Sharing: DebitMyData AI models that rely on shared datasets use blockchain to ensure secure and private data sharing between different entities. Blockchain's cryptographic techniques can ensure that data is only accessible to authorized AI algorithms, enhancing privacy.

5. DebitMyData AI-Driven Consensus Mechanisms. In blockchain, consensus mechanisms are used to validate transactions and ensure the security and reliability of the network. AI can improve consensus mechanisms by:
Optimizing Proof-of-Work (PoW) and Proof-of-Stake (PoS): The DebitMyData AI can analyze network performance, energy consumption, and transaction patterns to optimize traditional consensus mechanisms like PoW or PoS, making them more efficient.
Creating New AI-Driven Consensus Mechanisms: The DebitMyData AI can develop new consensus algorithms that are more secure or faster. For example, AI could analyze past attack patterns on blockchain networks and adjust the consensus mechanism to preemptively defend against future attacks.

6. Enhanced Security and Fraud Detection. AI can enhance blockchain security by:
Fraud Detection: The DebitMyData AI can continuously monitor blockchain transactions and detect fraudulent activities or anomalies. By analyzing transaction patterns, AI systems can alert network participants to potential threats before they escalate. When a suspicious transaction is identified by AI, blockchain ensures that the fraudulent transaction cannot be reversed or altered.
Cybersecurity: The DebitMyData AI-driven cybersecurity systems can defend blockchain networks from cyberattacks, such as Distributed Denial of Service (DDoS) attacks or attempts to tamper with the consensus process. The security data and response actions can be stored and verified on the blockchain for future audits

7. AI-Assisted Decentralized Finance (DeFi). Blockchain supports decentralized financial (DeFi) applications by eliminating intermediaries. The DebitMyData AI further enhances DeFi platforms by:
Predictive Analytics for Investment: DebitMyData AI analyzes on-chain data, market trends, and user behavior to predict profitable investments or trading opportunities. For example, in a DeFi platform, AI suggests optimal yield farming strategies based on market conditions and blockchain data.
Risk Assessment: DebitMyData AI evaluates risk by analyzing transaction histories and market volatility. It then provides recommendations or trigger smart contracts to adjust interest rates, collateral requirements, or insurance premiums automatically.

8. Interoperability Between Blockchains. AI facilitates interoperability between different blockchain networks as follows:
Cross-Chain Transactions: DebitMyData AI optimizes and automates cross-chain transactions, where assets or data need to be exchanged between different blockchain ecosystems, for example from Ethereum to Binance Smart Chain. AI algorithms can analyze transaction fees, speed, and security to find the most efficient route for cross-chain transfers.
Blockchain Bridges: DebitMyData AI automates the operation of blockchain bridges, which allow different blockchains to communicate and share data. AI can ensure that the data or tokens transferred between blockchains are secure, validated, and efficiently managed.

9. DebitMyData AI in NFTs and Smart Contracts. AI can directly interact with NFTs and smart contracts on the blockchain:
AI-Generated NFTs: As noted above, AI creates, manages, and optimizes NFTs, with the blockchain providing transparency and security around the ownership and trading of these assets.
AI-Augmented Smart Contracts: AI can enhance smart contracts by making them more dynamic and adaptable. For instance, AI can update a smart contract's conditions in real-time based on external data, for example market prices, weather data, or user behavior, and ensure the updated conditions are securely recorded on the blockchain.

10. Self-Sovereign Identity and AI-Driven Verification. Blockchain provides the foundation for decentralized identity systems (self-sovereign identity), and AI can assist in:
Identity Verification: DebitMyData AI verifies biometric data, for example facial recognition data and voice recognition data, and stores verification proof on the blockchain, ensuring that digital identities are secure and can be trusted across multiple platforms.
Dynamic Identity Updates: DebitMyData AI continuously monitors and updates a user's identity profile based on their interactions across different platforms. The blockchain records and secure these updates, providing users with control over their evolving digital identities.

DebitMyData AI and blockchain are complementary technologies, each enhancing the capabilities of the other. AI interacts directly with blockchain by driving smarter automation, improving security, optimizing performance, and enabling innovative applications such as decentralized data marketplaces, personalized NFTs, AI-driven DeFi platforms, and self-sovereign identity systems. The combination of AI's ability to process large datasets and make real-time decisions with blockchain's transparency and security may create opportunities for both industries. For DebitMyData, the integration of AI with blockchain leads to more secure, dynamic, and personalized services, especially in areas such as data monetization, identity verification, and NFT-based advertising.

The electronic wallet provided herein uses Non-Fungible Tokens (NFTs) and can benefit from integrating NFT technology into its platform. NFTs can be utilized within the electronic wallet as follows:

1. NFT Ownership and Management. The wallet allows users to securely store, manage, and transfer their NFTs. Users have full control over their digital assets, whether the assets are artwork, music, collectibles, or even assets such as real estate tokenized on the blockchain.
NFT Storage: Users can hold their NFTs within the wallet, providing them with easy access to view, trade, or sell their assets.
NFT Transfer: The wallet can facilitate peer-to-peer transfer of NFTs between users.
NFT Trading: Integration with decentralized NFT marketplaces will enable users to buy and sell NFTs directly from their wallets.

2. Custom Logo and Facial Recognition NFTs. A notable feature of DebitMyData is integration of custom logo and facial recognition NFTs into its platform. This technology may be embedded directly into the electronic wallet, enhancing both the personalization and security of the wallet.
Custom Logo NFTs: Users can create and manage NFTs with their own custom logos or branding, representing their identity or business.
Facial Recognition NFTs: These NFTs would use biometric data, such as the user's facial recognition information, to add an extra layer of security to access and verify transactions. Only the rightful owner would be able to access these NFTs, ensuring security and privacy.

3. Monetization Through NFTs. The electronic wallet provided herein allows users to monetize their NFTs by:
Selling Ad Space on NFTs: Users generate income by selling advertising space on their custom logo or facial recognition NFTs. Advertisers purchase this ad space, which would be embedded into the NFT. Each time the NFT is displayed, for example in marketplaces, social media, or within the wallet, the owner receives a portion of the advertising revenue.
NFT-Based Subscriptions: Users offer subscriptions to exclusive NFT-based content directly from their wallet, allowing for gated access to music, videos, or digital art.
NFT Auctions: Users could list their NFTs for auction, enabling dynamic pricing and competitive bidding among potential buyers.

4. NFT-Based Identity Verification. The electronic wallet uses NFTs for identity verification in a secure and transparent manner:
Decentralized Identity: Each user has an NFT that represents their digital identity, which is securely stored in their wallet. This identity NFT could include personal identifiers such as a verified email address, government-issued ID, or even biometric information.
Self-Sovereign Identity: By using NFTs for identity, users will have full control over their personal data and identity verification, without relying on centralized institutions.

5. Tokenizing Real-World Assets. The electronic wallet provided herein enables users to tokenize real-world assets as NFTs, making it easier for them to buy, sell, or trade fractional ownership of assets such as:
Real Estate: Users tokenize real estate properties into NFTs, enabling fractional ownership and easier transfers.
Luxury Goods: High-value items such as artwork, jewelry, or vehicles can be represented as NFTs, ensuring authenticity and secure ownership transfer.
Intellectual Property: Creative works like patents, trademarks, or digital media can be tokenized and sold as NFTs, providing secure proof of ownership and authenticity.

6. Proof of Future and NFTs. As part of the DebitMyData Proof of Future ecosystem, NFTs play a role in how the wallet interacts with future value:
Future Value Projection: NFTs can be integrated with the Proof of Future algorithm in which the value of data embedded in the NFT may increase over time as more users interact with it.
Staking and Rewards: Users can stake their NFTs within the wallet to generate additional income through rewards, which are paid out in tokens or additional NFTs.

7. Gamification and Metaverse Integration. The electronic wallet provided herein is integrated into metaverse environments and games, using NFTs as in-game assets or collectibles. The wallet allows:
Metaverse Tokens: Users hold NFTs that represent in-game items, avatars, virtual land, or other digital assets.
In-Game Economies: The wallet could be used to facilitate transactions between players in gaming environments, where NFTs are used for virtual goods, rewards, or special abilities.

8. Royalty and Licensing. For creators, the wallet facilitates royalty payments through NFTs:
Built-In Royalties: NFTs created in the wallet can have smart contracts that ensure the original creator receives a percentage of every sale or transfer in perpetuity.
Intellectual Property Licensing: Creators can license their NFTs for use in advertising, merchandising, or digital content, with royalties being paid through the wallet.

9. NFT Gifting. The wallet enables users to gift NFTs as follows:
Digital Gift Cards: NFTs representing gift cards can be created and gifted to other users, allowing the recipient to redeem them through the wallet.
Personalized Gifts: Users can create NFTs for special occasions, such as birthdays or anniversaries, and send them directly through the wallet.

The wallet integrates NFTs in multiple ways, providing users with the ability to store, trade, and monetize their digital assets while ensuring high levels of security through custom logo and facial recognition features. This integration may open up new revenue streams and opportunities for personalization, enhancing the overall functionality of the wallet.

Proof of Future (PoF), as a concept and mechanism, can be designed to support multiple blockchains, making it a versatile and cross-chain protocol. The DebitMyData Proof of Future system may be adapted to work across different blockchain ecosystems as follows:

1. Cross-Chain Compatibility. To support multiple blockchains, the Proof of Future (PoF) mechanism would need to be designed with cross-chain compatibility. This can be achieved by using technologies such as interoperable bridges, cross-chain oracles, and multi-signature wallets that allow different blockchains to communicate and share data securely.
Bridges: These are platforms that connect different blockchains, enabling assets and data to flow between them. For PoF, bridges could be used to transfer the future value of data or assets from one blockchain to another. For example, if the PoF system is operating on Ethereum, it can bridge to Solana, Binance Smart Chain, or Polygon to allow users to transfer the value of their NFTs, tokens, or data securely.
Cross-Chain Oracles: Oracles can provide real-time data from various blockchains, ensuring that the Proof of Future system is aware of data interactions and values across different networks. This may assist the system in recognizing which blockchain is being used and may support accurate future value calculations.

2. Smart Contract Interoperability. Smart contracts are essential for blockchain automation and can be coded such that they function on different blockchain platforms. The PoF mechanism would involve deploying smart contracts that are compatible with different blockchain environments such as Ethereum's Solidity and Polkadot's Substrate. These smart contracts would track data transactions, verify contributions, and manage payments for users across multiple networks.
Multi-Layer Contracts: Different versions of the PoF smart contract could be implemented for different blockchains. For example, Ethereum might handle heavy data contracts with higher gas fees, while blockchains like Solana or Binance Smart Chain (BSC) could manage faster, lower cost transactions.
Universal Access: By integrating multi-signature wallets or blockchain bridges, users could interact with the PoF system no matter which blockchain they are on. This also allows them to move their assets comprising NFTs and tokens between chains while maintaining the data integrity tracked by the Proof of Future system.

3. Multi-Blockchain Data Interaction. Proof of Future relies on tracking user-generated data and its future value, which can be recorded on any blockchain. By utilizing a layer-2 scaling solution or off-chain data layer, the PoF system could gather data from multiple blockchains, track interactions, and project future values for assets or transactions across these networks. A multi-blockchain data interaction may function as follows:
Interoperable Data Layers: These are off-chain or layer-2 solutions such as Polygon, Arbitrum, and Optimism that gather data from multiple blockchain sources and compile it into one single data pool. This data pool would then feed into the PoF system to calculate the future value of data across chains.
Aggregated Data and Value: Whether data is generated on Ethereum, Solana, or other blockchain, PoF can aggregate it and calculate the combined future value, providing support for users with assets on different chains.

4. NFT Interoperability Across Blockchains. Since DebitMyData is heavily focused on NFTs with facial recognition and custom logos, PoF could support NFTs from different blockchains. For example:
Cross-Chain NFTs: NFTs created on Ethereum could be bridged and used on Binance Smart Chain or Solana. The PoF system would track the usage and value of these NFTs, regardless of the blockchain they are on.
NFT Standards (ERC-721/ERC-1155): PoF is adaptable to support various NFT standards across different blockchains. By integrating with standards like ERC-721 (Ethereum), SPL (Solana), or BEP-721 (Binance), the system could track the lifetime interactions and monetization of these NFTs across chains.

5. Proof of Future Payments Across Blockchains. A central feature of the PoF mechanism is compensating users based on their data's projected future value. To support other blockchains:
Cross-Chain Payments: The PoF system can distribute payments across different blockchains. For example, if a user's data is primarily stored and used on Solana, but the payments are executed on Ethereum, the system could use a cross-chain bridge to transfer value between the chains.
Native Token Payments: PoF could pay users in different native tokens, for example ETH, BNB, or SOL, depending on which blockchain the data or NFT is being monetized. This flexibility would increase user adoption by offering rapid and efficient payment solutions across blockchains.

6. Layer 2 Scalability and Faster Transactions. For fast-growing projects, layer 2 solutions such as Polygon or Arbitrum can help scale the Proof of Future mechanism to other blockchains. These solutions may facilitate cheaper and faster transactions, which are critical when operating across multiple networks.
Gas Fees Optimization: Layer 2 technology reduces gas fees, allowing the PoF system to handle microtransactions or future value payments on a large scale without high operational costs.
Cross-Chain Execution: Layer 2 scalability enables cross-chain compatibility with minimal latency, allowing PoF to work fluidly across multiple blockchain networks.

7. Decentralized Identity Across Chains. Using decentralized identity protocols, PoF could help users maintain control over their data on multiple blockchains. This is especially useful for identity verification NFTs, which DebitMyData is integrating into its platform.
Decentralized Identity (DID): PoF could enable a decentralized identity system where users control their identity data and can use it across different blockchains for authentication or monetization purposes.

8. Governance and Voting Across Blockchains. As the Proof of Future system evolves, a decentralized governance model can be established where users vote on decisions regarding the system's future:
Cross-Chain Governance Tokens: Users could hold governance tokens on different blockchains and participate in decision-making across the ecosystem. The Proof of Future is designed to support multiple blockchains by utilizing cross-chain bridges, interoperable data layers, multi-chain smart contracts, and decentralized governance models. By embracing these technologies, PoF may provide a positive experience for users, enabling them to benefit from the future value of their data or NFTs across various blockchain networks. This cross-chain support increases flexibility and user engagement, making DebitMyData a robust and versatile platform.

The electronic wallet provided herein includes biometric security comprising facial recognition. The wallet includes an advanced facial recognition system that verifies the user's identity before granting access to wallet functions. This biometric data is securely stored and encrypted on the blockchain.

The security provided by the wallet also includes custom logo authentication. Users can create a custom logo that acts as an additional layer of security. This logo must be visually recognized by the user during login or transaction approval, enhancing the authentication process.

AI-Driven analytics provided herein comprise at least personalized financial management. The wallet uses AI algorithms to analyze the user's transaction history, asset usage, and market trends, providing personalized recommendations for financial management, investment strategies, and spending habits.

For optimization of placement of advertising for NFTs containing advertising space, AI analyzes user preferences and behaviors. The AI is directed to optimizing such placements, ensuring maximum engagement and revenue generation.

The electronic wallet also provides quantum-resistant encryption. The wallet observes encryption standard such that it employs quantum-resistant encryption protocols to protect sensitive data and transactions from potential quantum computing threats.

Future-proof security is also provided. The encryption system is designed to evolve with advancements in quantum computing, ensuring long-term security for users'digital assets and financial data.

Decentralized identity management is an important feature of the wallet. Under self-sovereign identity, users manage their digital identities through the wallet using decentralized identity (DID) protocols. This allows users to control their personal data and selectively share it with third parties, a crucial feature for financial institutions.

As discussed at length above, the wallet incorporates the proprietary Proof of Future algorithm, which calculates the value of a user's data based on energy exertion and allows users to generate cryptocurrency through this model.

For quantum communication integration, the wallet is designed to integrate with quantum communication grids, including wireless networks, satellite communications, IoT devices, and other quantum-enhanced communication systems. For secure data transmission, the wallet utilizes quantum key distribution (QKD) and other quantum communication techniques, to ensure that data transmitted through these grids is secure from interception and tampering.

Systems and methods also provide voice command and bone conduction technology. For voice-activated transactions, the wallet supports voice commands for executing transactions, accessing asset information, and navigating the wallet interface. This feature is powered by AI-driven natural language processing (NLP) algorithms.

To enhance privacy, the wallet employs bone conduction technology that allows only the user to hear voice prompts and confirmations through vibrations transmitted directly to the inner ear. This ensures that sensitive information is not overheard by others in the vicinity.

Systems and methods of the electronic wallet are directed to serve many industries. For banking and financial institutions, the card may serve as a credit, debit, and gift card solution. Financial institutions can integrate the wallet to offer secure, blockchain-based digital payment solutions to their customers. The wallet supports digital banking functions, including payments, transfers, and investment management, providing a comprehensive solution for banking institutions and credit unions.

For electronic commerce or E-Commerce and digital marketplaces, the wallet facilitates secure payments and NFT transactions within digital marketplaces, enhancing the buying and selling experience for consumers and merchants. For loyalty programs, retailers can integrate loyalty programs into the wallet, allowing users to earn and redeem points, discounts, or digital assets during purchases.

The wallet integrates with mobile carriers to provide secure payment solutions and digital identity management for mobile users. The wallet enables secure transactions and data management across Internet-of-Things (IoT) devices, ensuring that communications within connected ecosystems are protected.

For digital media and advertising platforms and as discussed above, the wallet supports management and monetization of digital content through NFTs, offering a secure and transparent platform for advertisers and content creators. The wallet can be used to manage subscriptions, payments, and digital assets within streaming platforms, providing a positive experience for users.

For quantum communications and satellite communications, the wallet's quantum-ready features enable secure data transmission over satellite networks, making it ideal for industries requiring high levels of data security. As quantum networks evolve, the wallet will integrate with these systems to provide next-generation security and transaction capabilities.

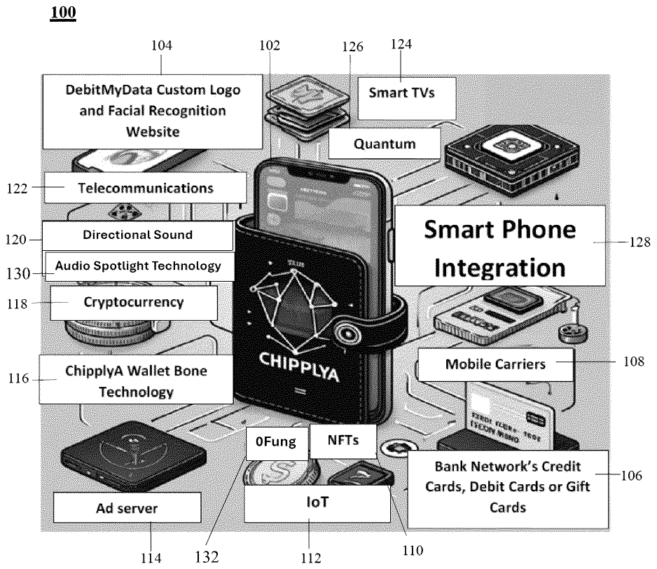

Turning to the figure, FIG. 1 depicts a system of an electronic wallet as described above. A system 100 is provided and the various aspects of the wallet are illustrated with the wallet. The system 100 comprises a portable electronic device 102 in which components of the electronic wallet are stored and executed. The system 100 also comprises the DebitMyData Custom Logo and Facial Recognition Website 104, all or parts of which may execute on the device 102. The system 100 also comprises bank networks' credit cards, debit cards or gift cards 106, mobile carriers 108, and NFTs 110.

The system 100 also comprises IoT 112, ad server 114, and ChipplyA Wallet Bone Technology 116. The system also comprises cryptocurrency 118, bone technology 120, and telecommunications 122. The system also comprises smart TV 124, quantum 126 and smart phone integration 128. The system also comprises audio spotlight technology 130 and 0Fung 132.

In an embodiment a system for managing digital assets held by digital wallets is provided. The system comprises an electronic device and an electronic wallet application stored at least in the device that when executed enables minting of at least one customer logo or facial recognition Non-fungible Token (NFT) as directed by user entries. The system also lists the NFT on a DebitMyData platform, receives a message that the NFT has been sold in a transaction, and validates and logs the transaction on a blockchain.

The DebitMyData platform integrates facial recognition technology with a blockchain-based NFT advertising model to allow users to place logos on NFTs and videos for sharing on social media and mobile devices. The DebitMyData platform pays users a percentage of advertising dollars spent by corporate sponsors and advertisers who use logos placed on NFTs by the users.

The application tokenizes personal data into NFTs and wherein the NFTs are manageable and tradeable on the blockchain. The application sells advertising space on NFTs and directs smart contracts to automate such transactions.

The application in selling the advertising on NFTs further comprises the application overseeing that payment is securely transferred to a user owning an NFT hosting the advertising. The application distributes a percentage of revenue from the selling of the advertising to the NFT creator's account. The system promotes categorization and management of assets within the digital wallet application based on at least one of type, value, and usage frequency of asset.

In another embodiment, a method for profitably using advertising space in Non-Fungible Tokens associated with digital wallet accounts is provided. The method comprises a computer executing a digital wallet application determining, during a review of subscriber accounts, that a subscriber owns Non-Fungible Tokens (NFTs) containing available advertising space. The method also comprises the computer analyzing previous preferences and behaviors of the subscriber. Based on the analysis, the method also comprises the computer selecting advertising content determined appropriate for the subscriber. The method also comprises the computer inserting the content into the available advertising space in the NFTs.

The method also comprises the computer selecting content to induce the subscriber to patronize products and services associated with the advertising. The method also comprises the computer employing quantum-resistant encryption protocols to protect data and transactions from quantum computing threats.

The method also comprises the computer entering transactions regarding the subscriber accounts on a blockchain. The method also comprises the computer accessing multiple blockchain networks comprising at least one of Ethereum, Bitcoin, and customer Layer 2 solutions, the accessing enabling integration with decentralized applications and smart contracts. The method also comprises the computer utilizing at least quantum key distribution to promote transmission of data that is secure from interception and tampering.

In yet another embodiment, a method for managing digital assets held by digital wallets is provided. The method comprises a computer executing a digital wallet application periodically reviewing digital assets held by accounts subscribing to the application. The method also comprises the computer applying artificial intelligence (AI) algorithms while analyzing transaction history, asset usage, and market trends affecting the digital assets held by the accounts. The method also comprises the computer recommending reconfiguration of assets belonging to selected accounts based at least on the AI algorithm analysis. The method also comprises the computer recording executed reconfiguration transactions on blockchain networks appropriate for the digital assets involved.

The digital assets comprise at least one of cryptocurrencies, Non-Fungible Tokens, and digital identity tokens. The reconfiguration transactions are executed in accordance with contractual relationships between entities managing the digital wallet applications and parties associated with the accounts.

The method also comprises the computer allowing accounts to manage their identities through the wallet application using decentralized identity (DID) protocols. The method also comprises the computer, via the application and to protect the accounts, complying with Anti-Money Laundering (AML) and Know Your Customer (KYC) regulations. The method also comprises the computer, via the application and to protect the accounts, adhering to industry standards for blockchain and digital asset management comprising at least one of standards set by the International Organization for Standardization (ISO) and standards set by the Payment Card Industry Data Security Standard (PCI DSS).

What is claimed is:

1. A system for managing digital assets held by digital wallets, comprising:
an electronic device;
an electronic wallet application stored at least in the device that when executed:
enables minting of at least one customer logo or facial recognition Non-fungible Token (NFT) as directed by user entries,
lists the NFT on a DebitMyData platform,
receives a message that the NFT has been sold in a transaction, and
validates and logs the transaction on a blockchain.

2. The system of claim 1, wherein the DebitMyData platform integrates facial recognition technology with a blockchain-based NFT advertising model to allow users to place logos on NFTs and videos for sharing on social media and mobile devices.

3. The system of claim 2, wherein the DebitMyData platform pays users a percentage of advertising dollars spent by corporate sponsors and advertisers who use logos placed on NFTs by the users.

4. The system of claim 1, wherein the application tokenizes personal data into NFTs and wherein the NFTs are manageable and tradeable on the blockchain.

5. The system of claim 1, wherein the application sells advertising space on NFTs and directs smart contracts to automate such transactions.

6. The system of claim 5, wherein the application in selling the advertising on NFTs further comprises the application overseeing that payment is securely transferred to a user owning an NFT hosting the advertising.

7. The system of claim 1, wherein the application distributes a percentage of revenue from the selling of the advertising to the NFT creator's account.

8. The system of claim 1, wherein the system promotes categorization and management of assets within the digital wallet application based on at least one of type, value, and usage frequency of asset.

9. A method for profitably using advertising space in Non-Fungible Tokens associated with digital wallet accounts, comprising:
a computer executing a digital wallet application determining, during a review of subscriber accounts, that a subscriber owns Non-Fungible Tokens (NFTs) containing available advertising space;
the computer analyzing previous preferences and behaviors of the subscriber;
based on the analysis, the computer selecting advertising content determined appropriate for the subscriber; and
the computer inserting the content into the available advertising space in the NFTs.

10. The method of claim 9, further comprising the computer selecting content to induce the subscriber to patronize products and services associated with the advertising.

11. The method of claim 9, further comprising the computer employing quantum-resistant encryption protocols to protect data and transactions from quantum computing threats.

12. The method of claim 9, further comprising the computer entering transactions regarding the subscriber accounts on a blockchain.

13. The method of claim 9, further comprising the computer accessing multiple blockchain networks comprising at least one of Ethereum, Bitcoin, and customer Layer 2 solutions, the accessing enabling integration with decentralized applications and smart contracts.

14. The method of claim 9, further comprising the computer utilizing at least quantum key distribution to promote transmission of data that is secure from interception and tampering.

15. A method for managing digital assets held by digital wallets, comprising:
a computer executing a digital wallet application periodically reviewing digital assets held by accounts subscribing to the application;
the computer applying artificial intelligence (AI) algorithms while analyzing transaction history, asset usage, and market trends affecting the digital assets held by the accounts;
the computer recommending reconfiguration of assets belonging to selected accounts based at least on the AI algorithm analysis; and
the computer recording executed reconfiguration transactions on blockchain networks appropriate for the digital assets involved.

16. The method of claim 15, wherein the digital assets comprise at least one of cryptocurrencies, Non-Fungible Tokens, and digital identity tokens.

17. The method of claim 15, wherein the reconfiguration transactions are executed in accordance with contractual relationships between entities managing the digital wallet applications and parties associated with the accounts.

18. The method of claim 15, further comprising the computer allowing accounts to manage their identities through the wallet application using decentralized identity (DID) protocols.

19. The method of claim 15, further comprising the computer, via the application and to protect the accounts, complying with Anti-Money Laundering (AML) and Know Your Customer (KYC) regulations.

20. The method of claim 15, further comprising the computer, via the application and to protect the accounts, adhering to industry standards for blockchain and digital asset management comprising at least one of standards set by the International Organization for Standardization (ISO) and standards set by the Payment Card Industry Data Security Standard (PCI DSS).
